(19) United States
(12) Patent Application Publication
(10) Pub. No.: US 2008/0257649 A1
(43) Pub. Date: Oct. 23, 2008

(54) OIL PAN WITH AN INTEGRALLY FORMED TUBE ASSEMBLY FOR HIGH PRESSURE OIL TRANSPORT

(76) Inventors: Michael J. Sameck, Lake Orion, MI (US); Patrick J. Nevin, Sterling Heights, MI (US); Robbe R. Campeau, Clarkston, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/736,098

(22) Filed: Apr. 17, 2007

(51) Int. Cl. F16N 31/02; B22D 46/00

(52) U.S. Cl. 184/106; 164/4.1

(57) ABSTRACT

The present disclosure provides an oil pan for an internal combustion engine with an integrally formed tube assembly for transporting high pressure oil from an oil pump to an oil filter and back. The oil pan uses a welded tube assembly including two tubes which are placed inside the oil pan during permanent mold casting. The two tubes are individually bent, then welded together, and finally leak tested. As part of the casting process, an end of the tube assembly for the oil pump is printed to a cope of the tool. Another end of the tube assembly for the oil filter includes a threaded fitting screwed into the tube assembly. The fitting prints into the cope of the tool.

### FIELD OF THE INVENTION

The present disclosure relates generally to oil pans in internal combustion engines, and more specifically, to an oil pan with an integrally formed tube assembly for transporting high pressure oil from an oil pump to an oil filter and back.

### BACKGROUND OF THE INVENTION

Oil pans are mounted to the engine block or crankcase of a vehicle or the like, and serve as a reservoir for the engine's oil. When the engine is running, an oil pump draws oil from the pan through a pickup tube in the oil pan's sump, and forces it through oil galleries which are small passageways that direct the oil to moving parts of the engine. Oil from the pan first passes through an oil filter being moving through the engine. The filter removes dirt, metal particles, and other debris and/or contaminants from the oil. Typically, passageways in the oil pan casting are either sand cored or drilled to allow the oil to flow between various points in the oil pan, such as between the oil pump and oil filter. Disadvantageously, sand cored passages are prone to breaking and destroying the casting in the process. Extra processing is further required to clean the cored sand out of the passages. Also, sand cored passages require a minimum parent material thickness between passages to seal against leaks. Drilled passages must be straight and the access holes must be plugged, leading to potential leaks.

### BRIEF SUMMARY OF THE INVENTION

In various exemplary embodiments, the present disclosure provides an oil pan for an internal combustion engine with an integrally formed tube assembly for transporting high pressure oil from an oil pump to an oil filter and back. The oil pan uses a welded tube assembly including two tubes which are placed inside the oil pan during permanent mold casting. The two tubes are individually bent, then welded together, and finally leak tested. As part of the casting process, an end of the tube assembly for the oil pump is printed to the cope of the tool. Another end of the tube assembly for the oil filter includes a threaded fitting screwed into the tube assembly. The fitting prints into the cope of the tool.

Advantageously, the present disclosure requires no plugging of the oil pan and no extra leak paths due to drilling. Because no sand cores are used, the passages have greater integrity and are free of debris. Also, the passage can be run very close together for tighter packaging. The oil pan with an integrally formed tube assembly of the present disclosure can be utilized with a difficult packaging issue to provide oil transport, and the present disclosure provides improved reach and joint quality.

In an exemplary embodiment of the present disclosure, an oil pan with an integrally formed tube assembly for high pressure oil transport includes a tube assembly comprising first and second tubes, wherein the tube assembly is shaped to reach a first position and a second position in the oil pan, and the first and second tubes are welded together. The tube assembly is integrally formed within the oil pan. The oil pan further includes a flanged portion extending outward from an exterior surface of the oil pan. The first position includes two openings on the flanged portion, and the second position is substantially in the middle of an inner surface of the oil pan. The first and second tubes include closed ends at the second position, and wherein openings are formed in the first and second tubes at a bottom location rear the second position. A threaded fitting is screwed into one of the openings at the second position prior to casting. The threaded fitting is unscrewed and two openings are drilled at the second position following casting. An oil pump connects to the tube assembly at the first position, and wherein an oil filter connects to the tube assembly at the second position.

In another exemplary embodiment of the present disclosure, a method for casting an oil pan with a tube assembly for high pressure oil transport includes obtaining a first and second tube, bending the first and second tubes according to a shape defined by a first and a second position in the oil pan, welding the first and second tubes together, leak testing the tube assembly, and placing the first and seconds tube in the oil pan, wherein a first end of the first and second tubes is placed at the first position and a second end of the first and second tubes is placed at the second position. The method further includes casting the oil pan with the first and second tubes in place. The method further includes drilling two openings at the second position following casting. Optionally, the method further includes closing the second end of the first and second tubes, and screwing a threaded fitting into the second tube at the second position. The threaded fitting allows the second tube to reach the second position to overcome bend radii limitations.

In yet another exemplary embodiment of the present disclosure, an oil pan with an integrally formed tube assembly for high pressure oil transport between an oil pump and an oil filter includes an inner surface of the oil pan with a sump portion and a pan portion, a flanged surface of the oil pan extending outward from an exterior surface of the oil pan, wherein the flanged surface includes two openings for the oil pump to connect, and a tube assembly with a first and second tube and a threaded fitting in the second tube, wherein the first and second tubes extend from the two openings on the flanged surface to a middle portion of the pan surface. The tube assembly is integrally formed with the oil pan, and holes are drilled in the middle portion to form openings for the oil filter to connect to the first tube and the threaded fitting in the second tube following casting.

### BRIEF DESCRIPTION OF THE DRAWINGS

The present disclosure is illustrated and described herein with reference to the various drawings, in which like reference numbers denote like system components, respectively, and in which:

FIG. 1 is a top perspective view of an exemplary embodiment of an oil pan;

FIG. 2 is a bottom perspective view of an exemplary embodiment of an oil pan;

FIG. 3 is a perspective view of a steel tube assembly utilized in the oil pan;

FIG. 4 is a perspective view of the steel tube assembly as shown in FIG. 3 after assembly and leak testing;

FIG. 5 is another perspective view of the steel tube assembly as shown in FIG. 3 after assembly and leak testing;

FIG. 6 is a close up perspective view of the positioning fitting of the steel tube assembly as shown in FIGS. 4 and 5;

FIG. 7 is a sectional view of the positioning fitting of the steel tube assembly including a threshold fitting inserted in one of the tubes;

FIG. 8 is a sectional view of the steel tube assembly attached to the oil pan following casting;

FIG. 9 is a top perspective view of an exemplary embodiment of an oil pan with the steel tube assembly cast in;

FIG. 10 is a bottom perspective view of an exemplary embodiment of an oil pan with the steel tube assembly cast in;

FIG. 11 is a side perspective view of an exemplary embodiment of an oil pan with the steel tube assembly cast in; and

FIG. 12 is a rear face perspective view of an exemplary embodiment of an oil pan.

### DETAILED DESCRIPTION OF THE INVENTION

In various exemplary embodiments, the present disclosure provides an oil pan for an internal combustion engine with an integrally formed tube assembly for transporting high pressure oil from an oil pump to an oil filter and back. The oil pan uses a welded tube assembly including two tubes which are placed inside the oil pan during permanent mold casting. The two tubes are individually bent, then welded together, and finally leak tested. As part of the casting process, an end of the tube assembly for the oil pump is printed to the cope of the tool. Another end of the tube assembly for the oil filter includes a threaded fitting screwed into the tube assembly. The fitting prints into the cope of the tool.

Advantageously, the present disclosure requires no plugging of the oil pan and no extra leak paths due to drilling. Because no sand cores are used, the passages have greater integrity and are free of debris. Also, the passages can be run very close together for tighter packaging. The oil pan and integrally formed tube assembly of the present disclosure can be utilized with a difficult packaging issue to provide oil transport, and the present disclosure provides improved reach and joint quality.

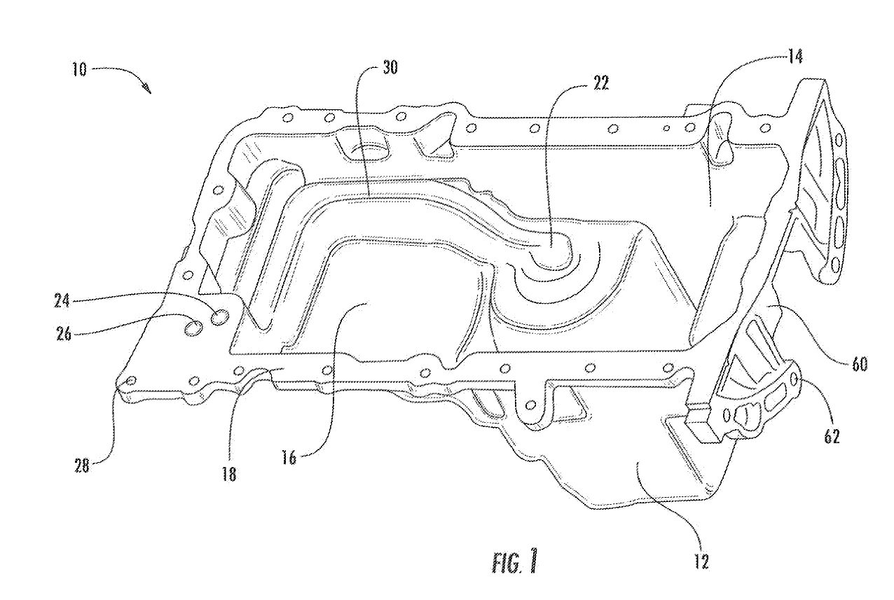

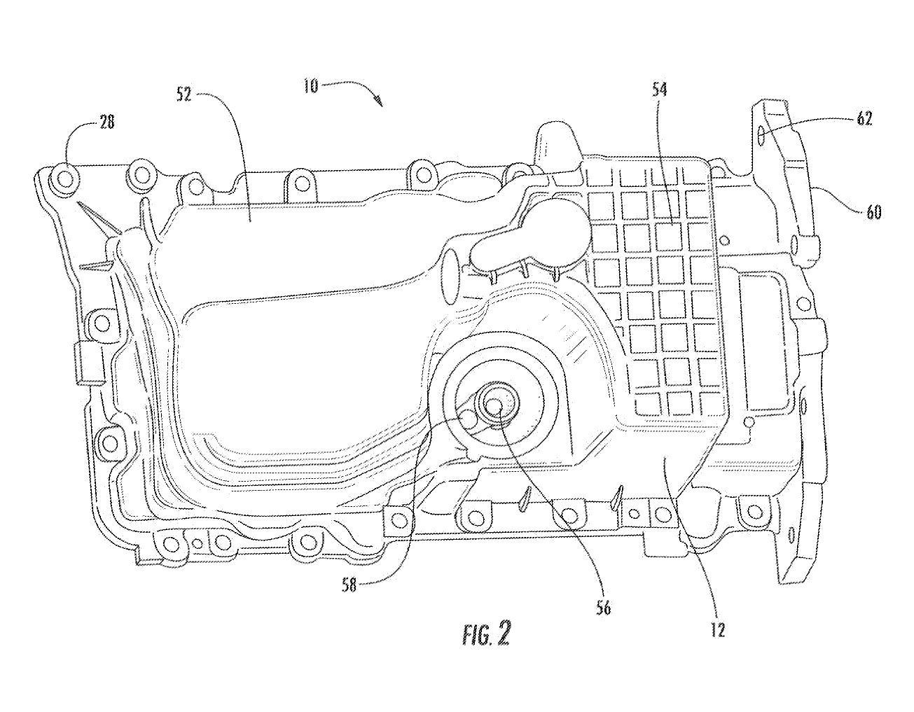

Referring to FIGS. 1 and 2, an oil pan 10 includes an exterior surface 12, a sump 14, and inner pan surface 16, and a flanged portion 18. FIG. 1 illustrates a top view and FIG. 2 illustrates a bottom view of the oil pan 10. The flanged portion 18 extends laterally outward from the exterior surface 12, and is continuous around the entire pan 10. The flanged portion 18 provides a means for the pan 10 to attach to an engine (not shown), and includes multiple holes 28 sized to receive fasteners, such as bolts, for mounting to the engine. The sump 14 is a reservoir for storing oil, and can include baffle plates and screens (not shown) to prevent oil from sloshing around in the pan 10. Additionally, a rear face 60 includes multiple holes 62 sized to receive fasteners, such as bolts, for mounting to the transmission (not shown). The bottom of the oil pan 10 includes a pan exterior surface 52 and a sump exterior surface 54.

The inner pan surface 16 includes a welded tube assembly 30 which is integrally formed with the oil pan 10, such as fixedly attached or manufactured together (e.g., cast in place). The tube assembly 30 runs substantially from the center of the pan 10 to the distal end of the pan 10 from the rear face 60. The tube assembly 30 extends from a middle position 22 located substantially in the center of the pan 10 to two openings 24 and 26 located on the flanged portion 18. In one embodiment of the present disclosure, the oil pan 10 provides for an oil filter located underneath the middle position 22. The oil filter mounts to two openings 56 and 58 below the middle of the oil pan 10 at the middle position 22. Traditionally, casting technology would utilize either sand cored passages or drilled passages within the casting to reach this oil filter location at the middle position 22. The distance and convoluted nature of the passages do not allow for reliable sand coring. Also, drilling is not ideal because four to six external plugs would be required to seal the resultant cross passages.

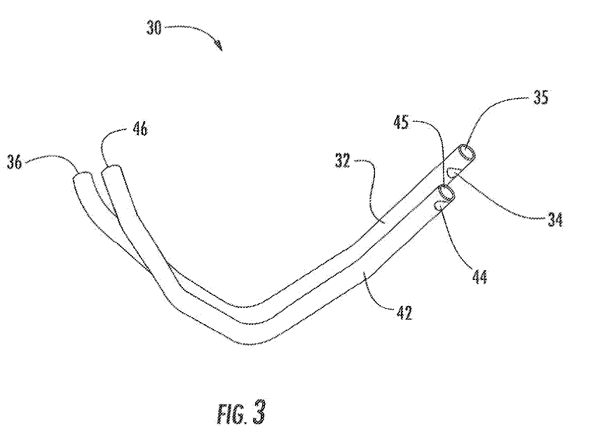

Referring to FIGS. 3 through 8, the present disclosure uses the welded steel tube assembly 30 which is integrally formed within the oil pan 10, such as, for example, during the permanent mold casting process. The tube assembly 30 removes the need to perform sand coring or drilling for the oil passages in the oil pan 10. Advantageously, the tube assembly 30 allows reach between the openings 56 and 58 at the middle position 22 and the openings 24 and 26 on the flanged portion 18. In addition to providing reach in a difficult packaging issue, the tube assembly provides better joint quality over conventional means. Those of ordinary skill in the art will recognize the welded steel tube assembly 30 can be utilized in any oil pan to provide improved oil transport in a difficult packaging issue between any points in the oil pan 10.

Referring specifically to FIG. 3, the tube assembly 30 includes two tubes 32 and 42 which are individually bent to fit between the opening 22 and the openings 24 and 26. The bending of the tubes 32 and 42 is according to the dimensions required in the oil pan 10 to reach between the end points, such as openings 56 and 58 at the middle position 22 and the openings 24 and 26 on the flanged portion 18. The tubes 32 and 42 provide high pressure oil transport to and from the oil pump at openings 24 and 26 and the oil filter at the openings 56 and 58. At one end, the tubes 32 and 42 include openings 36 and 46 which are adjacent to the openings 24 and 26. At the other end, the tubes 32 and 42 include openings 34 and 44 located on the tubes 32 and 46 and ends 35 and 45 which are closed.

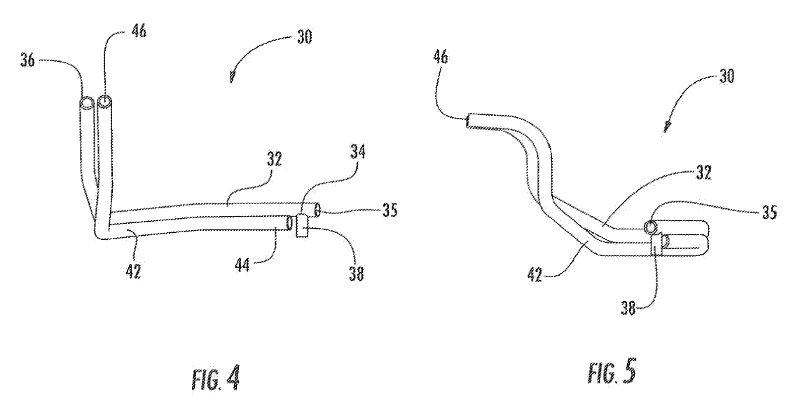

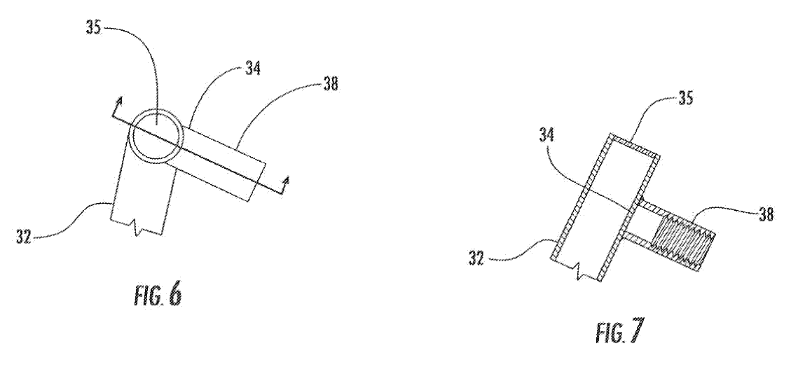

In an exemplary embodiment, as part of the casting process, the openings 36 and 46 at the oil pump end of the tube assembly 30 are printed to a cope prior to casting of the oil pan 10. The ends 35 and 45 and openings 34 and 44 at the oil filter end can not be bent to also print to the cope due to packaging and bend radii limitations associated with the tubes 32 and 42. Instead, the openings 34 and 44 are created in the tubes 32 and 42 at a bottom position, and the ends 35 and 45 are closed. A threaded fitting 38 is screwed into the opening 34 on the tube 32. The threaded fitting 38 and the opening 44 print into the cope of the tool The opening 44 is located adjacent to the opening 20 in the oil pan 10, and the threaded fitting 38 connects the opening 34 with the opening 20. FIGS. 4 and 5 each illustrate a different perspective view of the completed tube assembly 30, i.e., after the tubes 32 and 42 are bent, after the threaded fitting 38 is included, with the tubes 32 and 42 welded together, and after leak testing the tubes 32 and 42.

After the tube assembly 30 is assembled (as depicted in FIGS. 4 and 5), the tube assembly 30 is integrally formed with the oil pan 10. Following casting, the threaded fitting 38 is unscrewed, and openings 56 and 58 are drilled from where the filter mounts underneath the oil pan 10 to the tubes 32 and 42. The result is the oil pan 10 with side by side high pressure oil passages formed by the tube assembly 30 that are free of any leak risks, broken or blocked passages, and external plugs.

FIG. 6 illustrates a close up perspective view of the positioning fitting of the tube 32 after screwing in the threaded fitting 38. This view is shown looking into the end 35. The angle between the threaded fitting 38 and the tube 32 is approximately 75 degrees. As described herein, this precludes a bending of the tube 32. Accordingly, the threaded fitting 38 provides an extension to reach the oil pan 10 at the opening 56. Note the second tube 42 does not require a threaded fitting since its opening 44 is placed against the oil pan 10 in casting.

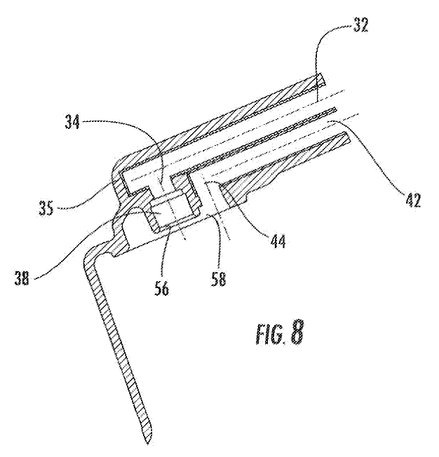

FIG. 7 illustrates a sectional view of the positioning fitting of the steel tube assembly 30 including a threshold fitting 38 inserted in the tube 32. The threshold fitting 38 can include a screw in rod which is inserted into the side of a mold prior to casting. Following casting, the rod is unscrewed, and the passages are drilled out to form the opening 56.

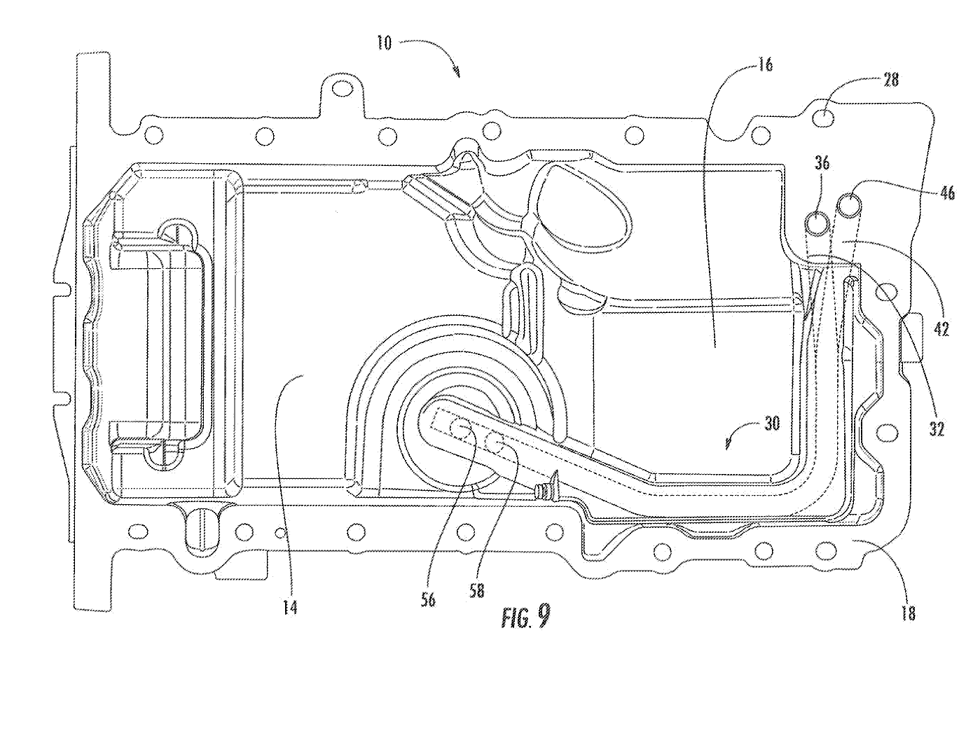

FIG. 8 illustrates a sectional view of the tube assembly 30 attached to the oil pan 10 following casting and drilling. As described herein, following welding and leak testing, the tube assembly 30 is printed to a cope for casting the oil pan 10. The oil pan 10 can be a die cast or made with a permanent mold. The tube 42 is placed adjacent to the interior surface 16 of the oil pan 10 so that the opening 44 lines up with the opening 58. The threaded fitting 38 connects the tube 32 to the opening 56. Following casting, the openings 56 and 58 are drilled. This drilling does not create potential leaks since the holes created by the drilling connect to the oil filter.

The threaded fitting 38 is used to overcome bend radii limitations. In another embodiment, as part of the casting process, the ends 35 and 45 could be printed to the cope without using the threaded fitting 38 and the openings 34 and 44. This could be used, for example, where the shaped of the tubes 32 and 42 allows for direct contact between the ends 35 and 45 at the location in the oil pan 10 where they terminate.

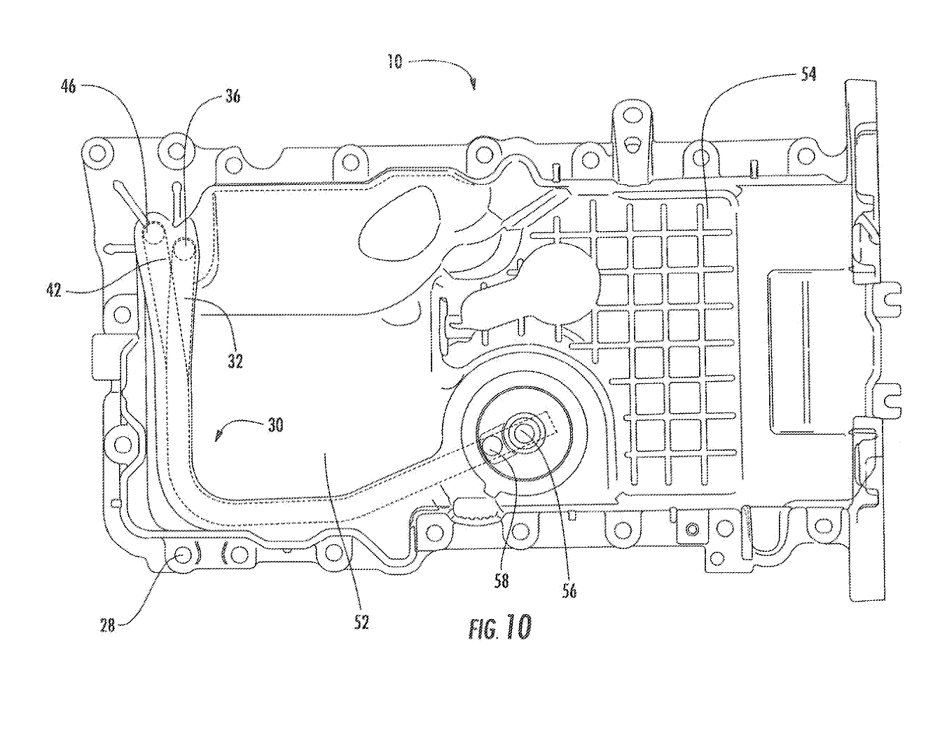

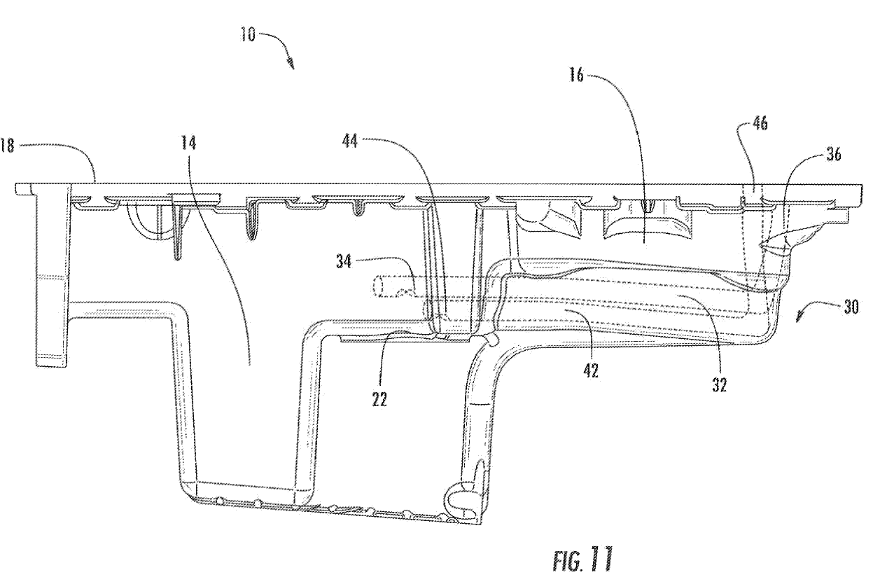

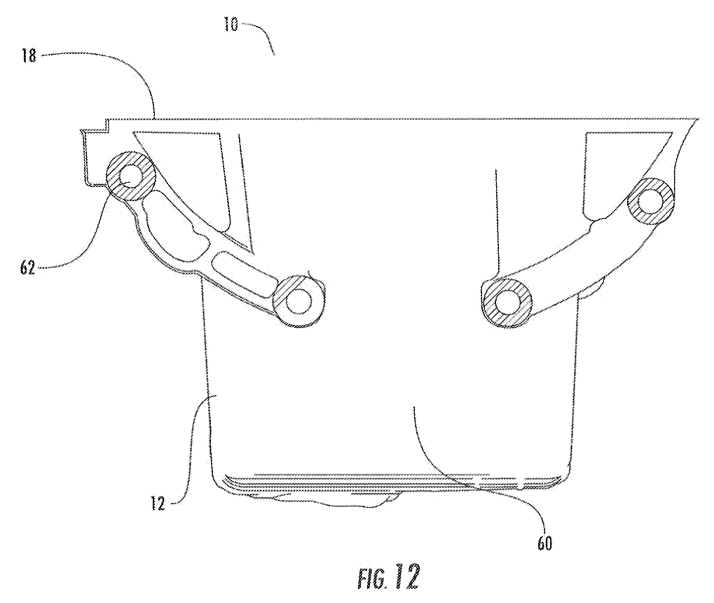

Referring to FIGS. 9 through 12, the oil pan 10 is illustrated in an exemplary embodiment with the tube assembly 30 integrally formed within the oil pan 10 to connect an oil pump with an oil filter for high pressure oil transport back and forth. An oil pickup (no shown), such as a rigid pipe, leads down into the sump 14 to the oil pump. The pickup enables the oil pump to retrieve oil from the oil pan 10. The oil pump connects to the openings 36 and 46 of the tube assembly 30. The oil pump uses tube 32 to transport oil received from the oil pickup to the oil filter located at the opening 34 at the other end of the tube 32. As described herein, the oil filter is located below the oil pan 10 at the middle position 22 in an exemplary embodiment. The oil filter receives the oil through the opening 56.

The oil filter includes a filtering medium to remove contaminants from the oil. After filtering, the oil is transported back to the oil pump through the opening 58 and tube 42. The oil pump receives the filtered oil back through opening 46 and proceeds to distribute the oil throughout the engine. Finally, the oil drips back from the engine to the oil pan 10 and the process repeats. Note, either tube 32 and 42 can be used for either direction of oil transport between the oil pump and oil filter.

FIGS. 9, 10, and 11 illustrate a top, bottom, and side perspective view, respectively, of the oil pan 10 showing the tube assembly 30 integrally formed. FIG. 12 illustrates a rear face perspective view of the oil pan 10 showing the machined area which the transmission mounting bolt rests on. As described herein, the tube assembly 30 can be utilized for any oil pan 10 to provide transport of oil from one location to another in the oil pan 10. The exemplary embodiments of FIGS. 9-12 are provided for illustration purposes showing an oil filter located in the middle of the oil pan 10.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure and are intended to be covered by the following claims.

What is claimed is:

1. An oil pan with an integrally formed tube assembly for high pressure oil transport, comprising:
a tube assembly comprising first and second tubes;
wherein the tube assembly is shaped to reach a first position and a second position in the oil pan, and wherein the first and second tubes are welded together;
wherein the tube assembly is integrally formed within the oil pan.

2. The oil pan of claim 1, further comprising a flanged portion extending outward from an exterior surface of the oil pan.

3. The oil pan of claim 2, wherein the first position comprises two openings on the flanged portion, and wherein the second position is substantially in the middle of an inner surface of the oil pan.

4. The oil pan of claim 3, wherein the first and second tubes comprise closed ends at the second position, and wherein openings are formed in the first and second tubes at a bottom location near the second position.

5. The oil pan of claim 4, wherein a threaded fitting is screwed into one of the openings at the second position prior to casting.

6. The oil pan of claim 5, wherein the threaded fitting is unscrewed and two openings are drilled at the second position following casting.

7. The oil pan of claim 6, wherein an oil pump connects to the tube assembly at the first position, and wherein an oil filter connects to the tube assembly at the second position.

8. A method for casting an oil pan with a tube assembly for high pressure oil transport, comprising:
obtaining a first and second tube;
bending the first and second tubes according to a shape defined by a first and a second position in the oil pan;
welding the first and second tubes together;
leak testing the tube assembly; and
placing the first and second tubes in the oil pan, wherein a first end of the first and second tubes is placed at the first position and a second end of the first and second tubes is placed at the second position.

9. The method for casting an oil pan of claim 8, further comprising casting the oil pan with the first and second tubes in place.

10. The method for casting an oil pan of claim 9, further comprising drilling two openings at the second position following casting.

11. The method for casting an oil pan of claim 8, further comprising:
closing the second end of the first and second tubes;
screwing a threaded fitting into the second tube at the second position.

12. The method for casting an oil pan of claim 10, wherein the threaded fitting allows the second tube to reach the second position to overcome bend radii limitations.

13. The method for casting an oil pan of claim 11, further comprising casting the oil pan with the first and second tubes in place.

14. The method for casting an oil pan of claim 12, further comprising drilling two openings at the second position following casting.

15. An oil pan with a integrally formed tube assembly for high pressure oil transport between an oil pump and an oil filter, comprising:
an inner surface of the oil pan comprising a sump portion and a pan portion;
a flanged surface of the oil pan extending outward from an exterior surface of the oil pan, wherein the flanged surface comprises two openings for the oil pump to connect; and
a tube assembly comprising a first and second tube and a threaded fitting in the second tube, wherein the first and second tubes extend from the two openings on the flanged surface to a middle portion of the pan surface;
wherein the tube assembly is integrally formed with the oil pan, and wherein holes are drilled in the middle portion to form openings for the oil filter to connect to the first tube and the threaded fitting in the second tube following casting.
